(19) United States
(12) Patent Application Publication
(10) Pub. No.: US 2019/0359786 A1
(43) Pub. Date: Nov. 28, 2019

(54) PROCESS FOR EXPANDING EXPANDABLE POLYMERIC MICROSPHERES

(71) Applicant: Living Proof, Inc., Boston, MA (US)

(72) Inventors: Lauren A. Trahan, Boston, MA (US); Ronald Patrick McLaughlin, Boston, MA (US)

(21) Appl. No.: 16/348,644

(22) PCT Filed: Nov. 10, 2017
(86) PCT No.: PCT/US2017/060981

§ 371 Date: May 9, 2019

Related U.S. Application Data
(60) Provisional application No. 62/420,873, filed on Nov. 11, 2016.

(51) Int. Cl. C08J 9/18; B01F 7/16; B01F 15/06; B01F 7/00; B29C 44/34; C08J 9/04

(52) U.S. Cl. CPC C08J 9/18; B01F 7/165; B01F 15/065; B29K 2105/0076; B29C 44/3461; C08J 9/04; B01F 2015/062; B01F 7/00208

(57) ABSTRACT

The present process is directed to a solvent-free process of expanding expandable polymeric hollow, fluid-filled microspheres.

### RELATED APPLICATION

This application claims priority to U.S. Provisional Application No. 62/420,873, filed Nov. 11, 2016, the entire contents of which are incorporated herein by reference.

### BACKGROUND

“Flat” or “limp” are common complaints for consumers with fine, thin hair. These consumers want a product that results in an increase in the volume of their hair, making the hair appear more bulky and full. Some products alter the hair fiber-to-fiber interactions and fix the hairs into a specific style. Other products incorporate solid particles to increase the diameter of the hair fiber and or increase friction to make individual hair fibers look and feel thicker. Unfortunately, many of these solutions are heavy, and, while they may give an initial boost in volume, weight the hair down over time.

Recently, a new volumizing product was developed that uses hollow, fluid-filled microspheres as a means of providing volume and texture to hair without weighting it down over time (see PCT Application No. PCT/US2016/012693, the teachings of which are incorporated herein by reference). The hollow microsphere can consist of a thermoplastic polymer shell and are filled with a fluid (liquid or gas) such that, when heated, the thermoplastic polymer shell softens and the fluid inside expands (liquid to gas, gas to expanded gas), resulting in a sphere that expands like a balloon up to as much as four times its initial size. After the heat source is removed, the shell stays in its deformed/expanded state. Accordingly, when applied to hair, the expanded hollow, fluid-filled microspheres increase the volume of the hair.

Due to the heat required to expand these microspheres, it is preferable to expand them to a specific particle size using heat prior to incorporation into a cosmetic composition. Unfortunately, the existing method for expanding polymeric microspheres are problematic for later incorporating the expanded polymeric microspheres into a cosmetic product. One common method for expanding polymeric microspheres is by slurrying the spheres in a solvent, typically water, and heating. For example, U.S. Pat. No. 4,179,546 discloses a method for expanding a microsphere by dispersing it in an aqueous medium containing hydrogen peroxide and exposing the microspheres to heat. Similarly, U.S. Pat. No. 3,914,360 discloses a method for expanding microspheres by dispersing them in a liquid medium, such as water, and heating the resulting dispersion to a temperature sufficient to cause expansion of the microspheres by passing the dispersion through a heated interfacial surface generator. U.S. Pat. No. 3,611,583 discloses a method for expanding a microsphere by slurrying the microsphere in a liquid, depositing a thin film of the dispersion on a heated conveyer to expand the microsphere and evaporating the dispersing liquid. EP Publication No. EP2838863 teaches a method for expanding a dry particle using a steam generator and fluidized bed reactor. Alternatively, U.S. Pat. No. 4,397,799 discloses a method for expanding a microsphere by dispersing the unexpanded microsphere in a volatile liquid, and spray drying the material by atomizing the dispersion into a stream of hot gas, such that the gas vaporizes the volatile liquid and expands the microsphere.

The downside of this approach used in U.S. Pat. Nos. 4,179,546 and 3,914,360 is that the resultant, expanded microsphere is still in a dispersion of a liquid such as water, and in the case of U.S. Pat. No. 4,179,546, with trace amounts of hydrogen peroxide. Thus, the resultant, expanded microsphere is still in a dispersion of another liquid, which may not be desired in the finished product. Furthermore, introducing water to the material minimizes the length of time that the expanded material without risk of microbial contamination. Additionally, equipment described in U.S. Pat. Nos. 3,914,360 and 3,611,583 and EP Publication No. EP2838863 is not commonly used in the cosmetic industry and would require a significant investment. The downside of the U.S. Pat. No. 4,397,799 approach is both ensuring that all liquid is vaporized. Additionally, spray drying is challenging to control the particle size in process. Finally, use of an aqueous medium requires removal of the water prior to incorporation of the expanded microsphere into an anhydrous system such as the one described in PCT Application No. PCT/US2016/012693.

Therefore, new solvent-free processes for expanding microspheres that do not rely on specialized equipment are needed.

### SUMMARY

In contrast to the previous methods described for expanding microspheres, the present process is directed to a solvent-free process of expanding expandable polymeric hollow, fluid-filled microspheres. In one aspect, the process comprises the steps of agitating unexpanded expandable polymeric hollow fluid-filled microspheres in a vessel in the absence of solvent; and heating the vessel such that a free flowing mixture of expanded microspheres is formed; thereby expanding the expandable polymeric microsphere to a larger particle size of a specific size. “Solvent-free”, as used herein refers a process that does not include any liquids. In particular, the microspheres are added dry to the vessel, and then are agitated and heated to expand the microsphere. The process described herein uses heat and agitation to ensure uniform heat transfer to yield a free-flowing particle of uniform particle size.

In particular, this invention relates to a process of expanding thermoplastic polymer, fluid-filled microspheres in a jacketed vessel fitted with a single-motion agitator comprising an anchor-type frame and shaft, with horizontal, pitched blades welded alternately to the frame and shaft, and scraper blades affixed to the frame, sufficient to provide adequate turnover of the microspheres along the sidewalls of the tank, such that the resultant product is a free-flowing powder of specific, larger particle size.

### BRIEF DESCRIPTION OF THE FIGURES

FIG. 1A is a schematic illustration of an apparatus for carrying out the invention.

FIG. 1B is a schematic illustration of the flow characteristics exhibited by said mixing configuration.

FIG. 2 is a bar graph showing the particle size distribution of the unexpanded material versus material expanded via the process outlined in the present invention. The distributions of the expanded material are very consistent over all three trials.

FIG. 3 is a picture of various of scraper designs that can be used in the present invention.

### DETAILED DESCRIPTION

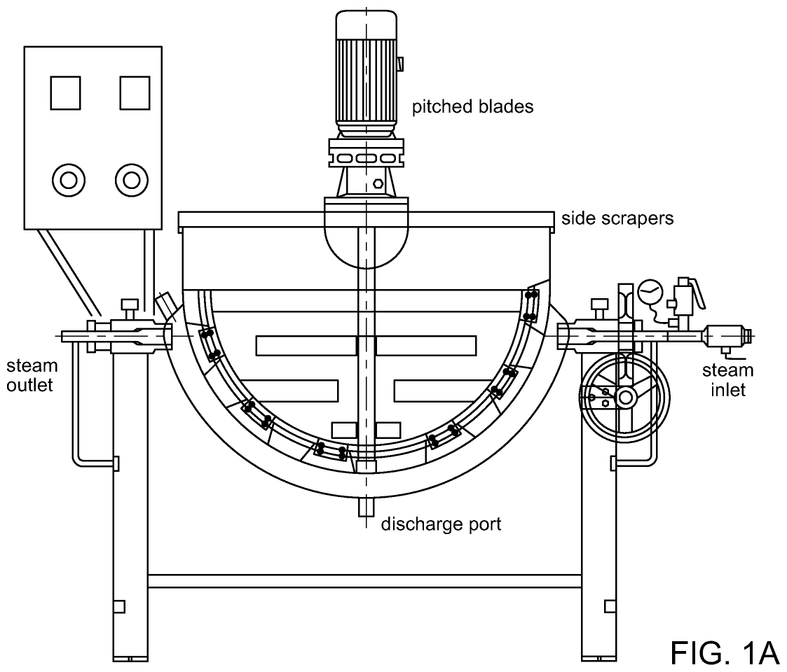

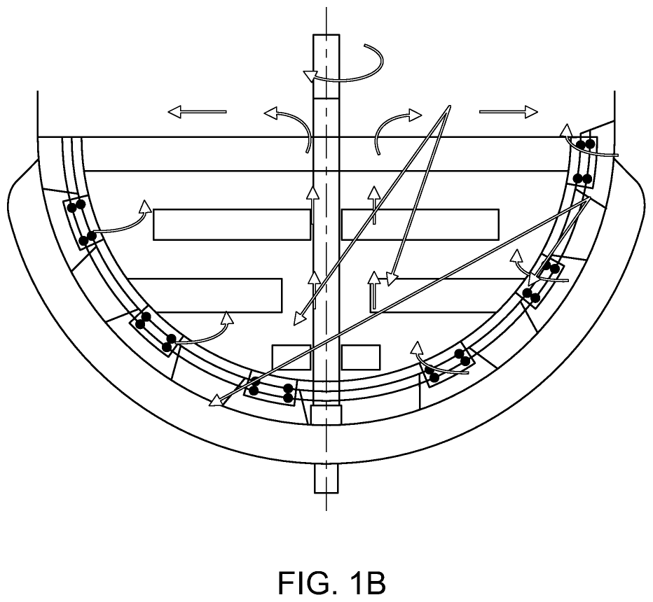

In one embodiment of the invention is a solvent-free process of expanding expandable polymeric hollow, fluid-filled microspheres comprising the steps of agitating unexpanded expandable polymeric hollow fluid-filled microspheres in a vessel in the absence of solvent; and heating the vessel such that a free flowing mixture of expanded microspheres is formed; thereby expanding the expandable polymeric microsphere to a specific, larger particle size. A representative apparatus for the present process is shown in FIG. 1A and FIG. 1B.

In some embodiments, the microspheres are agitated while heating. In a particular aspect, the microspheres are continuously agitated while heating. “Continuously agitated” means that the microspheres are mixed throughout the heating step without interruption. In a further aspect, the microspheres are agitated before and during heating. In particular, the microspheres are continuously agitated before and during heating. In yet a further aspect, the microspheres are agitated before, during, and after heating. In yet a further aspect, the microspheres are continuously agitated before, during and after heating.

As used herein “an agitator” is defined as a mechanism used to put something in motion by shaking or stirring. In some embodiments, the vessel further comprises an agitator that continuously moves the microspheres by shaking or stirring such that the material in contact with the side-walls of the vessel is kept moving. In some embodiments, the agitator comprises an impeller attached to a rotating shaft.

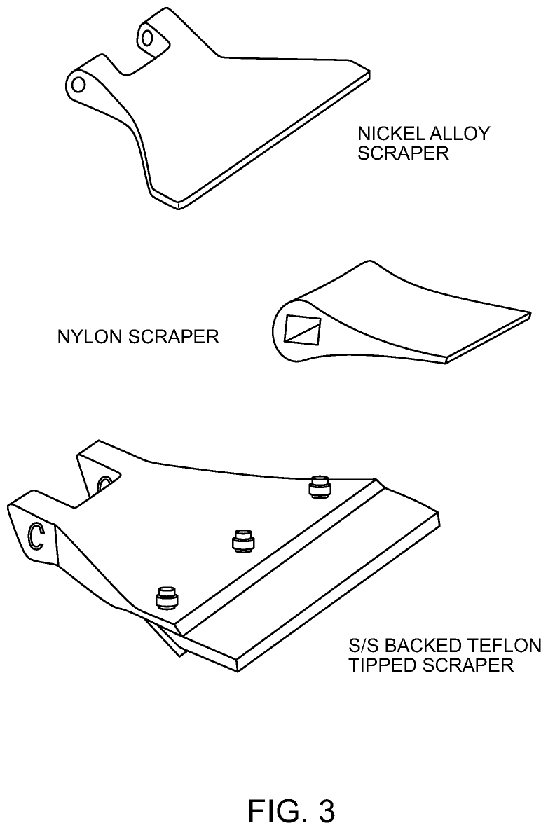

In some embodiments, the vessel further comprises one or more scraper blades. Scraper blades consist of a blade, mounted to the anchor frame of the main agitator such that they continually scrape the entire heated inside surface of the vessel, to prevent scorching or a build-up of insulating product film on the side wall of the vessel. In some aspects, the scraper blade comprises a blade that continually scrapes the interior surface of the vessel, thereby preventing scorching or a build-up of a product film on the interior side wall of the vessel. In some aspects, the scraper blades are selected from the group consisting of a stainless steel scraper; a nickel alloy scraper; a S/S backed, Teflon® (Polytetrafluoroethylene)-tipped scraper; a Teflon® (Polytetrafluoroethylene) scraper; a Ryton® (Polyphenylene Sulfide) scraper; a ultra-high molecular weight polyethylene (UHMWPE) scraper; a scraper made of other plastics common to one skilled in the arts; or a combination of any of the above materials. Various scraper blades are shown in FIG. 3.

In some embodiments, the agitator is selected from the group consisting of a scraper style agitator, a double motion scraper style agitator, a counter-rotating scraper style agitator, a full sweep agitator, a full scrape agitator, an anchor stirrer, a spiral or screw type agitator, a horizontal blender with paddle agitator, a horizontal ribbon blender, a single-motion agitator, and an anchor-type frame and shaft. In particular, the agitator is a single-motion agitator. In particular, the single-motion agitator is an anchor-type frame and shaft. In some embodiments, the anchor-type frame and shaft has horizontal, pitched blades welded alternately to the frame and shaft, and scraper blades affixed to the frame.

In some embodiments, the vessel is a jacketed vessel. In some aspects, the jacketed vessel is a container that is designed for controlling the temperature of its contents, by using a cooling or heating jacket around the vessel through which a cooling or heating fluid is circulated. In some aspects, the heating fluid is steam or hot water. Alternatively, an electric heat band could be used to heat a vessel when a jacketed vessel is unavailable. In some aspects, the jacketed vessel is selected from the group consisting of conventional, half-pipe coils, and dimple. In a particular aspect, the vessel is heated with an electric heat band. In some aspects, the vessel is heated to 40 to 210° C. In particular, the vessel is heated to 75 to 105° C. In particular, the vessel is heated to 40 to 105° C., 40 to 85° C., 40 to 65° C., 50 to 115° C., 50 to 95° C., 50 to 75° C., 60 to 125° C., 60 to 105° C., 60 to 95° C., 70 to 135° C., 70 to 115° C., 70 to 105° C., 80 to 145° C., 80 to 125° C., 80 to 115° C., 90 to 155° C., 90 to 135° C., 90 to 115° C., 100 to 165° C., 100 to 145° C., 100 to 125° C., 110 to 175° C., 110 to 155° C., 110 to 135° C., 120 to 185° C., 120 to 165° C., 120 to 145° C., 130 to 195° C., 130 to 175° C., 130 to 155° C., 140 to 205° C., 140 to 185° C., 140 to 165° C., 150 to 210° C., 170 to 200° C., or 180 to 190° C.

In some embodiments, the volume is sufficient to contain the final volume of the expanded polymeric hollow fluid-filled microspheres. In particular, the tank capacity of the vessel should hold (d³)×the initial volume of material, where d=the increase in particle size (e.g., if the initial particle size is 25 micron and the desired end particle size is 50 micron, 50=d×25, so d is 2). Therefore, tank capacity of the vessel required to expand 10-L of unexpanded material to 2 times the initial particle size would be (2³)×10-L or 80-Liters total. Thus, a two-fold increase in radius would result in an eight-fold increase in volume and the vessel must be large enough to accommodate eight times the volume occupied by the unexpanded material.

In some embodiments, the volume, specific gravity and particle size of the expanded expandable microspheres is measured during the heating step. In some aspects, the measurement occurs during the heating step. Alternatively, the measurement occurs after the heating step.

In some embodiments, the expandable polymeric microspheres are expanded to a particle size of about 10 to about 120 micron.

In some embodiments, the process further includes the step of cooling the expanded expandable microspheres.

In some embodiments, the unexpanded microspheres are added to the vessel, the vessel is closed, and the agitator is started. The vessel is heated by running steam or hot water through the jacket. The microspheres are constantly mixed while heating to ensure turnover at the side walls. Mixing and heating is maintained until the material in the tank has expanded to fill the desired volume. Once the expanded volume is achieved, the vessel is cooled by running cool water through the jacket. Mixing is maintained while the microspheres cool. Samples are evaluated for both specific gravity using a pycnometer and particle size using laser light scattering particle size analysis (LLPSA).

In one embodiment, the invention is a process for expanding expandable polymeric hollow, fluid-filled microspheres steam-jacketed vessel, fitted with a single-motion agitator, wherein the agitator consists of an anchor-type frame and shaft with horizontal, pitched blades welded alternately to the frame and shaft, and scraper blades affixed to the frame. In a particular aspect the vessel has a 40 gallon capacity. In another particular aspect, the scraper blades are nylon.

In one embodiment, the invention is a process for expanding expandable polymeric hollow, fluid-filled microspheres in a jacketed vessel, fitted with a single-motion agitator, wherein the agitator consists of an anchor-type frame and shaft, and scraper blades affixed to the frame. In a particular aspect the vessel has a 200 gallon capacity. In another particular aspect, the scraper blades are nylon.

Hollow, Fluid-Filled Microspheres

Fluid-filled microspheres consist of a hollow shell, typically constructed using a polymer. As used herein, a “microsphere” (or “microparticle”) is of any geometric shape (i.e., a sphere, a cylinder, a cube, an ovoid, etc. or of an irregular shape). The term “fluid” as used herein, means a liquid or a gas which tends to take the shape of its container, container being the wall of the flexible microspheres. The shell is filled with a liquid or gas, typically air or a hydrocarbon like isobutane. When heated above the shell's glass transition temperature, the pliable and non-rigid shell softens and the fluid inside expands (liquid to gas, gas to expanded gas), resulting in a sphere that expands like a balloon up to as much as four times its initial size (see https://www.akzonobel.com/expancel/knowledge_center/tutorials/one/ for additional information, the teachings of which are herein incorporated by reference). After the heat source is removed, the shell stays in its deformed/expanded state.

In some embodiments, the microspheres used in the composition, such as the compositions described in PCT Application No. PCT/US2016/012693, are expanded prior to inclusion in the composition. In particular, the microspheres used in the present invention are expanded with heat prior to combination with the other components of the compositions described herein. As such, no further heat is needed to expand the microspheres, and the microspheres will provide an instant volumizing effect upon application to the hair.

The polymer is typically a thermoplastic polymer. In some embodiments of the invention, the microspheres comprise a thermoplastic material wall. In particular, the thermoplastic material is a polymer or copolymer of at least one monomer selected from the group consisting of acrylates, methacrylates (for example, methylacrylates) styrene, substituted styrene, unsaturated dihalides (for example, 1,1-dichloroethene (also referred to as vinylidene chloride), acrylonitriles, methacrylonitriles, vinyl and vinyl chloride. In a specific embodiment, the thermoplastic material is a acrylonitrile/methyl methacrylate/vinylidene chloride copolymer. In another specific embodiment, the thermoplastic material is an acrylonitrile/methacrylonitrile/methyl methacrylate copolymer. In another specific embodiment, the thermoplastic material is an acrylonitrile/methyl methacrylate copolymer.

In another aspect, the fluid-filled microsphere comprises a copolymer of either Acrylonitrile/Methyl Methacrylate/Vinylidene Chloride Copolymer, Acrylonitrile/Methacrylonitrile/Methyl Methacrylate Copolymer, or equivalent thermoplastic copolymer, such as that sold under the tradename EXPANCEL® by Akzo Nobel. In one embodiment, EXPANCEL® 461 DE 20 d70 (Acrylonitrile/Methyl Methacrylate/Vinylidene Chloride Copolymer, Isobutane), EXPANCEL® 461 WEP 20 d36 (acrylonitrile/methyl methacrylate/vinylidene chloride copolymer), or EXPANCEL® 551 DE 40 d42 (Acrylonitrile/Methyl Methacrylate/Vinylidene Chloride Copolymer, Isobutane), each made from a copolymer of acrylonitrile, methyl methacrylate and vinylidene chloride monomers can be used as the fluid-filled microsphere.

In one embodiment, EXPANCEL® 920 DU 80 (Acrylonitrile/Methacrylonitrile/Methyl Methacrylate Copolymer, Isobutane) and EXPANCEL® 920 WEP (Acrylonitrile/Methacrylonitrile/Methyl Methacrylate Copolymer, Isobutane), each made from a copolymer of acrylonitrile, methacrylonitrile and methyl methacrylate monomers can be used as the fluid-filled microsphere.

In one embodiment, EXPANCEL® FG52 DU 80 (Acrylonitrile/Methyl Methacrylate Copolymer, Isobutane), made from a copolymer of acrylonitrile and methyl methacrylate monomers can be used as the fluid-filled microsphere.

In another aspect, the fluid-filled microsphere comprises a polymer shell consisting of either acrylonitrile copolymer or polyvinylidene chloride copolymer with a calcium carbonate coating, such as that sold under the tradename Dualite® polymeric microspheres by Henkel. In one embodiment, Dualite® E135-040D (Acrylonitrile Copolymer, Calcium Carbonate) or Dualite® E130-055D (Polyvinylidene Chloride Copolymer, Calcium Carbonate) can be used as the fluid-filled microsphere. Other Dualite® microspheres with a larger particle size can be used, however, such microspheres may be visible on the hair. To reduce the visibility of the larger-sized microspheres, such microspheres could be coated with a coloring agent or an agent that modifies the refractive index to reduce the visibility of the microsphere on hair.

In another embodiment, the thermoplastic material is a copolymer with a lower softening temperature that would expand when exposed to heat from a styling tool, such as, but not limited to a commercial blow-drier, heated brushes (example, T3 Volumizer Heat Brush) hair crimping iron, curling iron, curling wand, hot rollers or other curling implements, rotating hot iron (example, Instyler®) or conventional flat straightening iron), for example, from about 40 to about 230° C.; from about 40 to about 200° C.; from about 40 to about 150° C.; from about 40 to about 100° C.; from about 40 to about 50° C. In one embodiment, the thermoplastic material is a copolymer with a lower softening temperature that would expand when exposed to heat from a commercial blow-drier, for example, from about 40 to about 50° C. One of skill in the art would be able to measure the softening temperature based upon known protocols. For example, one of skill in the art could run analysis of thermal transitions using Differential Scanning calorimetry (DSC) to determine the glass transition temperature, or softening temperature of the copolymer. In some embodiments, the copolymer is made from at least one monomer selected from the group consisting of acrylates, methacrylates, styrene, α-methyl styrene, substituted styrene, vinyl acetate, unsaturated dihalides, nitriles, acrylonitriles, and methacrylonitriles. In some embodiments, when the microspheres are made from a copolymer with a lower softening temperature, the microsphere may or may not be expanded prior to inclusion in the present composition.

Microspheres have a mean particle size between about 10 and about 40 or about 10 and about 120 micron. Microspheres with a mean particle size greater than about 40 micron will add volume, but are more easily visible to the naked eye. Microspheres with a mean particle size smaller than 10 micron may also be used to add volume. However, the risk of inhalation exposure in an aerosol application is increased for particle sizes below 10 micron. In one embodiment, the microspheres have a mean particle size of about 15 and 25 micron or about 10 to about 40 micron. In a particular embodiment, the microspheres have a mean particle size of about 20 micron.

The fluid-filled microspheres of the present invention, when in their expanded state, have a low density, between 0.01 g/cm³ and 0.6 g/cm³ depending on the material. In one embodiment, the density is about 0.01 to about 0.07 g/cm³. In one embodiment, the density is about 0.01 to about 0.1 g/cm³; about 0.01 to about 0.05 g/cm³; about 0.01 to about 0.5 g/cm³; about 0.01 to about 0.4 g/cm³; about 0.01 to about 0.3 g/cm³; about 0.01 to about 0.2 g/cm³; about 0.05 to about 0.2 g/cm³; about 0.01 to about 0.09 g/cm³; or about 0.01 to about 0.08 g/cm³.

The fluid-filled microspheres of the present invention, when used without further expansion, have a low density, between 0.01 g/cm³ and 1.2 g/cm³, depending on the material. In one embodiment, the density is about 0.02 to about 0.6 g/cm³. In one embodiment, the density is about 0.01 to about 0.1 g/cm³; about 0.01 to about 0.05 g/cm³; about 0.01 to about 0.5 g/cm³; about 0.01 to about 0.4 g/cm³; about 0.01 to about 0.3 g/cm³; about 0.01 to about 0.2 g/cm³; about 0.05 to about 0.2 g/cm³; about 0.01 to about 0.09 g/cm³; or about 0.01 to about 0.08 g/cm³. In one embodiment, the density is about 0.1 to about 1.2 g/cm³; about 0.2 to about 1.2 g/cm³; about 0.3 to about 1.2 g/cm³; about 0.4 to about 1.2 g/cm³; about 0.5 to about 1.2 g/cm³; about 0.6 to about 1.2 g/cm³; about 0.7 to about 1.2 g/cm³; about 0.8 to about 1.2 g/cm³; about 0.9 to about 1.2 g/cm³; about 1.0 to about 1.2; or about 1.1 to about 1.2.

### EXEMPLIFICATION

### Example 1 the Solvent-Free Expansion of Microspheres

The fluid-filled microspheres were placed in a 40 gallon capacity, steam-jacketed vessel, manufactured by Lee Industries, fitted with a single-motion agitator, that consists of an anchor-type frame and shaft with horizontal, pitched blades welded alternately to the frame and shaft, and nylon scraper blades affixed to the frame. No solvent was added.

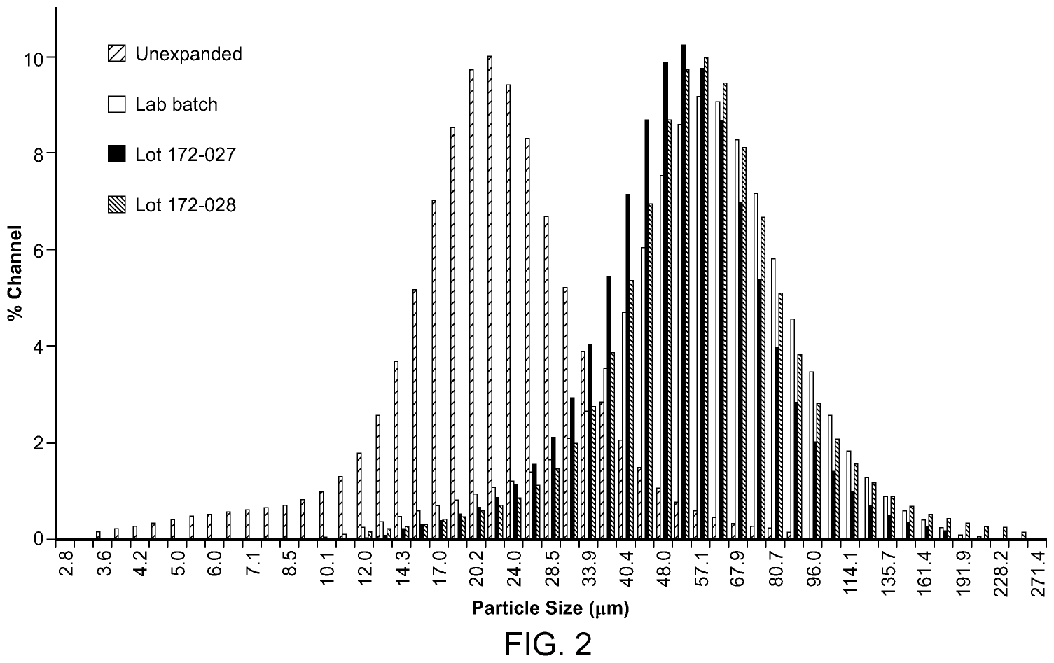

The above described process yields consistent results, as outlined in the table below and shown in FIG. 2:

| Batch | Specific Gravity | Mean Particle Size |
|---|---|---|
| Unexpanded | 0.500 | 20.83 μm |
| Lab batch, | 0.075 | 55.06 μm |
| Expanded | | |
| Large scale, | 0.061 | 49.71 μm |
| Expanded (Lot | | |
| #172-027) | | |
| Large scale, | 0.070 | 54.26 μm |
| Expanded (Lot | | |
| #172-028) | | |

### Example 2 the Solvent-Free Expansion of Microspheres

The fluid-filled microspheres were placed in a 200 gallon capacity, jacketed vessel, manufactured by Groen, fitted with a single-motion agitator that consists of an anchor-type frame and shaft, and nylon scraper blades affixed to the frame. No solvent was added. The above process afforded the results below.

| Batch | Specific Gravity | Mean Particle Size |
|---|---|---|
| Unexpanded | 0.500 | 20.83 μm |
| Large scale, Expanded | 0.055 | 54.3 μm |
| (Lot #175-178) | | |

### Example 3 Slurry Method for Expanding Microspheres

On lab scale, microspheres were slurried into water. The resulting slurry was heat to above the expansion temperature (approximately 85-95° C.). Prior to processing the microsphere slurry, the unexpanded microspheres in the slurry would fall to the bottom of the container if the mixing was stopped. After heating, the particles in the slurry floated to the top of the container, indicating a change in density. Samples were evaluated for and particle size using laser light scattering particle size analysis (LLPSA):

| Batch | Mean Particle Size |
|---|---|
| Unexpanded | 20.83 μm |
| Lab batch, Expanded | 22.56 μm |
| in water | |

The results above indicate that, although there was some expansion, the expansion in water did not yield a large enough change in particle size of the microspheres.

### Example 4 Slurry Method for Expanding Microspheres

On a large scale, a second attempt was made to expand the microspheres in water. The aqueous slurry of microspheres was heated for 90 minutes total, with samples pulled at various time points beginning 30 minutes after reaching the expansion temperature. The resulting product was not uniform. Although some particles were floating on the surface of the water, indicating a change in density, there were still unexpanded microspheres visible in each sample that had settled to the bottom of the container.

### Example 5 Use of Scrapers in the Process for Expanding Microspheres

On lab scale, small volumes (˜100 grams) of the microspheres were successfully expanded without solvent using a conventional 4-blade pitched impeller without scrape agitation. On this scale, the mixing dynamics from the impeller was sufficient to keep material turning over along the side walls of the beaker. However, when a conventional pitched impeller was used in production of a larger volume (12 kgs), the mixing was insufficient to turn the larger volume of product over along the side walls of the vessel. In this instance, the microspheres in contact with the side walls of the tank expanded first. As they expanded, they pressed against the unexpanded microspheres at the core of the tank, closest to the mixing blade. The increased pressure caused the expanding microspheres to compress into a solid, styrofoam like material and was no longer a free-flowing powder.

1. A solvent-free process of expanding expandable polymeric hollow, fluid-filled microspheres comprising the steps of:
agitating unexpanded expandable polymeric hollow fluid-filled microspheres in a vessel in the absence of solvent; and
heating the vessel such that a free flowing mixture of expanded microspheres is formed; thereby expanding the expandable polymeric microsphere to a specific, larger particle size.

2. (canceled)

3. The process of claim 1, wherein the microspheres are continuously agitated while heating.

4. (canceled)

5. The process of claim 1, wherein the microspheres are continuously agitated before and during heating.

6. (canceled)

7. The process of claim 1, wherein the microspheres are continuously agitated before, during and after heating.

8. The process of claim 1, wherein the vessel further comprises an agitator that continuously moves the microspheres by shaking or stirring such that the material in contact with the side-walls of the vessel is kept moving.

9. The process of claim 8, wherein the agitator comprises an impeller attached to a rotating shaft.

10. The process of claim 1, wherein the vessel further comprises one or more scraper blades.

11. The process of claim 10, wherein the scraper blade comprises a blade that continually scrapes the interior surface of the vessel, thereby preventing scorching or a build-up of a product film on the interior side wall of the vessel.

12. The process of claim 11, wherein the scraper blades are selected from the group consisting of a stainless steel scraper; a nickel alloy scraper; a S/S backed, Teflon® (Polytetrafluoroethylene)-tipped scraper; a Teflon® (Polytetrafluoroethylene) scraper; a Ryton® (Polyphenylene Sulfide) scraper; a ultra-high molecular weight polyethylene (UHMWPE) scraper; a scraper made of other plastics common to one skilled in the arts; or a combination of any of the above materials.

13. The process of claim 8, wherein the agitator is selected from the group consisting of a scraper style agitator, a double motion scraper style agitator, a counter-rotating scraper style agitator, a full sweep agitator, a full scrape agitator, an anchor stirrer, a spiral or screw type agitator, a horizontal blender with paddle agitator, a horizontal ribbon blender, a single-motion agitator, and an anchor-type frame and shaft.

14. The process of claim 13, wherein the agitator is a single-motion agitator.

15. (canceled)

16. The process of claim 13, wherein the anchor-type frame and shaft has horizontal, pitched blades welded alternately to the frame and shaft, and scraper blades affixed to the frame.

17. The process of claim 1, wherein the vessel is a jacketed vessel.

18. The process of claim 17, wherein the jacketed vessel is a container that is designed for controlling the temperature of its contents, by using a cooling or heating jacket around the vessel through which a cooling or heating fluid is circulated.

19. The process of claim 18, wherein the heating fluid is steam or hot water.

20. The process of claim 17, wherein the jacketed vessel is selected from the group consisting of conventional, half-pipe coils, and dimple.

21. The process of claim 1, wherein the vessel is heated with an electric heat band.

22. The process of claim 1, wherein the vessel is heated to 40 to 210° C.

23. (canceled)

24. The process of claim 1, wherein the volume is sufficient to contain the final volume of the expanded polymeric hollow fluid-filled microspheres.

25. The process of claim 1, wherein the volume, specific gravity and particle size of the expanded expandable microspheres is measured during the heating step.

26. The process of claim 25, wherein the measurement occurs during the heating step.

27. The process of claim 25, wherein the measurement occurs after the heating step.

28. The process of claim 1, wherein the expandable polymeric microspheres are expanded to a particle size of about 10 to about 120 micron.

29. (canceled)

30. A process for expanding expandable polymeric hollow, fluid-filled microspheres steam-jacketed vessel, fitted with a single-motion agitator, wherein the agitator comprises an anchor-type frame and shaft with horizontal, pitched blades welded alternately to the frame and shaft, and scraper blades affixed to the frame.

31. (canceled)

32. A process for expanding expandable polymeric hollow, fluid-filled microspheres in a jacketed vessel, fitted with a single-motion agitator, wherein the agitator comprises an anchor-type frame and shaft, and scraper blades affixed to the frame.

33. (canceled)

34. (canceled)
